(19) United States
(12) Patent Application Publication
(10) Pub. No.: US 2017/0177706 A1
(43) Pub. Date: Jun. 22, 2017

(54) Category-Based Search System and Method for Providing Application Related Search Results

(71) Applicant: Quixey, Inc., Mountain View, CA (US)

(72) Inventors: Jonathan BEN-TZUR, Sunnyvale, CA (US); Guy HADAS, Mountain View, CA (US)

(21) Appl. No.: 15/381,778

(22) Filed: Dec. 16, 2016

Related U.S. Application Data
(60) Provisional application No. 62/268,223, filed on Dec. 16, 2015.

(51) Int. Cl. G06F 17/30

(52) U.S. Cl. CPC G06F 17/30601; G06F 17/30522; G06F 17/30554

(57) ABSTRACT

A method is provided and includes: receiving at a processor of a user device a search query for an application; and obtaining search results based on the search query. Each of the search results includes: access information including a reference to an application executable on the processor and indicating an operation for the application to enter an operating state, where the application provides content related to the search query while in the operating state; a category; and a tag indicating a function of the application. The method further includes: displaying a search result objects; displaying a category or a tag for each category or tag represented in the search results; receiving an input indicating one of the categories or tags, which has been selected; and based on the selected category or tag, displaying a subset of the search results corresponding to the one of the categories or tags.

### CROSS-REFERENCE TO RELATED APPLICATIONS

This application claims the benefit of U.S. Provisional Application No. 62/268,223, filed on Dec. 16, 2015. The entire disclosure of the application referenced above is incorporated by reference.

### FIELD

This disclosure relates to search systems and methods for providing application related search results at a user device.

### BACKGROUND

The number of available software applications (referred to herein as “Apps”) has grown for user devices, such as computers, smartphones, mobile devices, televisions, in-vehicle computers, and other Internet-connected devices. Many diverse native and web-based software applications are available and can be accessed by the user devices. The applications include business related applications, game applications, educational applications, news applications, shopping applications, messaging applications, media streaming applications, social networking applications, etc.

Applications are used to accomplish specific functions and/or tasks. Applications have corresponding application states, which are used to accomplish each task and/or function. As an example, the application states can refer to windows and/or a set of display objects presented to a user to allow the user to accomplish and/or request performance of certain tasks and/or functions. As the number of applications, the complexity of the applications, and/or complexity of corresponding websites increases, it becomes ever more difficult to identify a correct application and/or application state to accomplish a given task and/or function.

### SUMMARY

A method is provided and includes: receiving at a processor of a user device a search query for an application; and obtaining at the processor search results based on the search query. Each of the search results includes: access information including a reference to an application executable on the processor and indicating an operation for the application to enter an operating state, where the application provides content related to the search query while in the operating state; a category; and a tag indicating one or more functions of the application. The method further includes: displaying at the user device a search result object for each search result; displaying at the user device a category or a tag for each category or tag represented in the search results; receiving an input from a user interface indicating one of the categories or tags of the search results, which has been selected; and based on one of the categories or tags, displaying a subset of the search results corresponding to the one of the categories or tags.

In other features, a system for search results is provided. The system includes: a processor; a memory; and a first application. The first application is stored in the memory and includes instructions, which are executable by the processor and that are configured to: receive as a user input a search query at a user device; and obtain search results based on the search query. Each of the search results includes: access information including a reference to a second application executable on the processor and indicating an operation for the second application to enter an operating state, wherein the second application provides content related to the search query while in the operating state; a category; and a tag indicating one or more functions of the application. The operations further include: displaying at the user device a search result object for each search result; displaying at the user device a category or a tag for each category or tag represented in the search results; receiving an input from a user interface indicating one of the categories or tags of the search results; and based on the one of the categories or tags, displaying at the user device a subset of the search results corresponding to the one of the categories or tags.

In other features, a search server is provided and includes a processor, a memory, and a first application. The first application is stored in the memory and including instructions, which are executable by the processor and that are configured to: receive a search query from a user device at the search server; and conduct a search based on the search query to obtain search results. Each of the search results includes: access information including a reference to a second application executable on the processor and indicating an operation for the second application to enter an operating state, wherein the second application provides content related to the search query while in the operating state; a category; and a tag indicating one or more functions of the application. The operations further include: transmitting the search results to the user device; receiving from the user device a first filter signal indicating one of the categories or tags; based on the first filter signal, filtering the search results to a subset of the search results corresponding to the category or the tag; and transmitting the subset or an indication as to which of the search result not to display to the user device.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

FIG. 1 is a perspective and functional block diagrammatic view of an example search system in accordance with the present disclosure.

FIG. 2 is a functional block diagram of a portion of the search system of FIG. 1.

FIG. 3 is a functional block diagram of an example user device in accordance with the present disclosure.

FIG. 4 is a functional block diagram of a portion of the search system illustrating generation of search results in accordance with the present disclosure.

FIG. 5 is a functional block diagram of an example search server in accordance with the present disclosure.

FIG. 6 is a front view of the user device illustrating search results objects and triggering of categorical filtering of search results in accordance with the present disclosure.

FIG. 7 is a front view of the user device illustrating categories and search result objects in accordance with the present disclosure.

FIG. 8 is a front view of the user device illustrating filtered search result objects.

FIG. 9 is a view of an example of a portion of a function relation tree including function categories and function tags in accordance with the present disclosure.

FIG. 10 is a view of an example application state record in accordance with the present disclosure.

FIG. 11 illustrates a user device method for performing a categorical search in accordance with the present disclosure.

FIG. 12 is a search server method for performing a categorical search in accordance with the present disclosure.

FIG. 13 is a perspective view of an example computing device executing methods described herein

Like reference symbols in the various drawings indicate like elements.

### DETAILED DESCRIPTION

A user of a user device may input a generic term as a search query (i.e. characters/terms to be searched) into a search field of a search engine and/or an executed search application. The generic term may be ambiguous, such that the search intent of the user is unclear. As a result, numerous search results (sometimes referred to as “verticals”) are provided by the search engine. Examples of search results are website links, images, videos, and informational text. It can be difficult to disambiguate the generic term (or terms) to determine what exact results for which the user is searching. For example, if the user entered “sf giants” for San Francisco Giants, the search results may be associated with ticket sales, references, products, directions, etc. Search results for “SF Giants” could include results linked to a booking application for buying tickets to a Giants game, a reference application for reading about the history of the Giants team, or a mapping application for getting directions to the Giant's ballpark. This may occur because the user does not specify what type of application state, task and/or function the user intends to find by having a search conducted.

Systems and methods set forth herein include providing categories for users to select and have search results filtered to disambiguate search query terms. The systems efficiently provide users improved search results for applications. The methods include filtering, sorting and/or grouping application search results based on the tasks and/or functions a user selects to have performed. Application search results may correspond to states, tasks and/or functions implemented on user devices, system servers and/or other computers of the search system.

In some examples, each search result corresponds to an application state described in an application state record. Each application state record may include access information, a function category, and/or a function tag. The access information facilitates access to the corresponding application state. The function category describes a type or grouping of functions (e.g., an event category, a reference category, or a local business category). The function tag specifies an action that may be performed in a corresponding application state (e.g., buying tickets, displaying an article for reading, getting and/or displaying directions, etc.). Categories of search results and corresponding tasks and functions may be connected in a nested tree. The search results may be sorted based on a user selected category and/or tag, which provides the user with search results related to the selected category and/or tag. Allowing a user to select categories, filtering the search results, and using a nested tree enables disambiguation of search query terms.

### System Overview

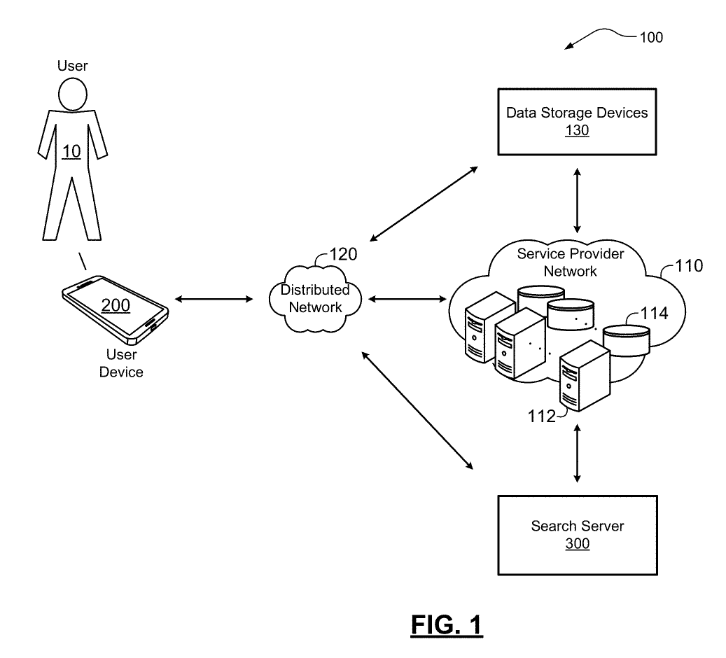

FIG. 1 shows a search system 100 that includes a user device 200 associated with a user 10. The search system 100 also includes a service provider network 110, a distributed network 120, data storage devices 130, and a search server 300. The user device 200 is in communication with the service provider network 110 via the distributed network 120. The service provider network 110 may be part of or separate from the distributed network 120. In one embodiment, the service provider network 110 is implemented as a cloud-based network. The service provider network 110 includes scalable/elastic computing resources, such as servers 112 and/or virtual machines (not shown) implemented by the servers 112. The service provider network 110 further includes storage resources, such as data storage devices 114. The user device 200 and/or the service provider network 110 may communicate with the search server 300 and receive data from the one or more data storage devices 130. In some implementations, the search server 300 communicates with one or more user devices 200 and the data storage device(s) 130 via the distributed network 120. The search server 300 may be implemented in the service provider network 110. The distributed network 120 may include various types of networks, such as a local area network (LAN), a wide area network (WAN), and/or the Internet.

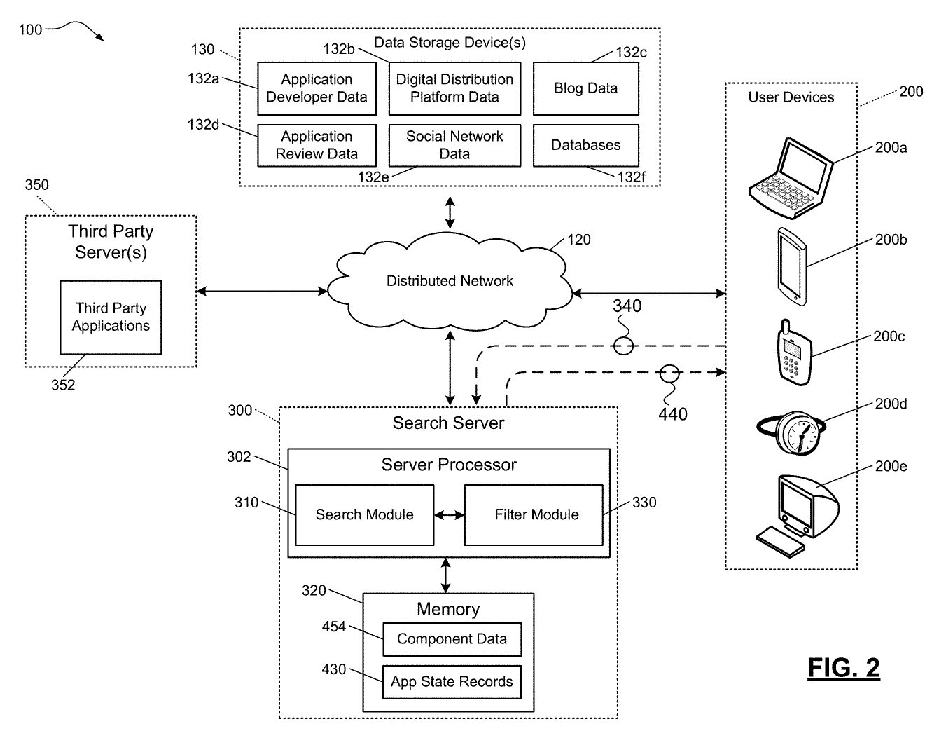

FIG. 2 shows a portion 102 of the search system 100 of FIG. 1. The portion 102 includes the distributed network 120, the data storage devices 130, one or more user devices 200 (examples of which are shown as user devices 200a-e), the search server 300 and third party servers 350. The data storage devices 130 may store application developer data 132a, digital distribution platform data 132b, blog data 132c, application review data 132d, social network data 132e, and databases 132f (collectively referred to as data 132).

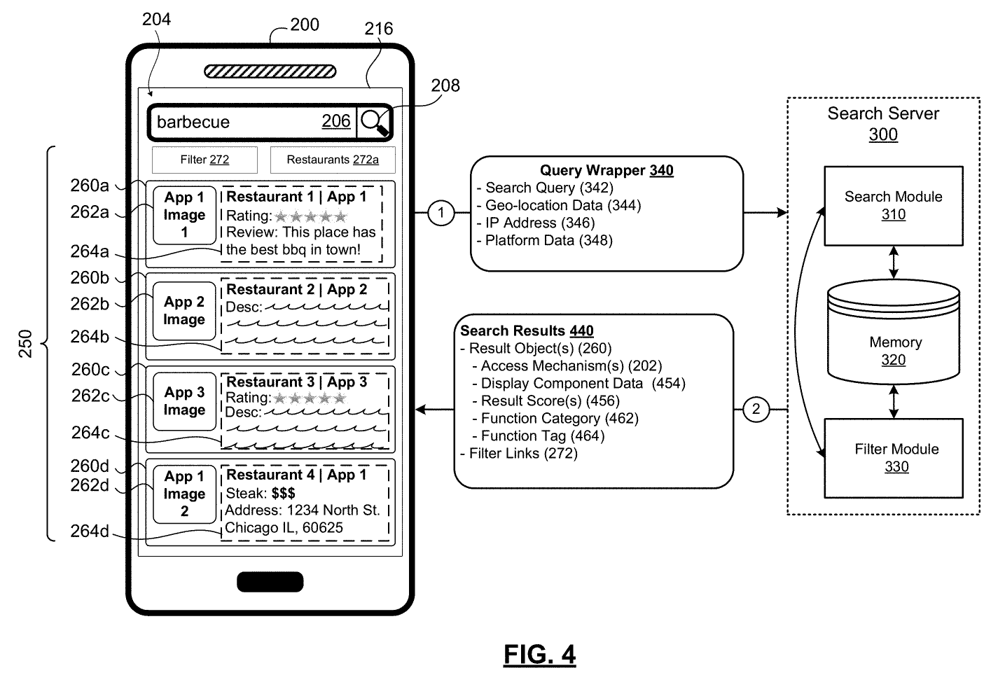

The user devices 200 may be mobile computing devices, such as a laptop 200a, a tablet 200b, a smart phone 200c, and/or a wearable computing device 200d (e.g., headsets and/or watches). The user devices 200 may also include other computing devices having other form factors, such as desktop computers 200e, computing devices included in a vehicle, gaming devices, televisions, and/or appliances (e.g., networked home automation devices and home appliances). The user device 200 may be a computing device that is capable of providing search queries 342 (shown in FIG. 4) in query wrappers 340 (shown in FIG. 4) to the search server 300.

The search server 300 includes a server processor 302 and memory 320. The server processor 302 may include and/or execute a search module 310 and a filter module 330 and or include search and filter applications executable by the server processor 302 and adapted to perform operations performed by the modules 310, 330. The memory 320 stores App state records 430 and display component data 454. The third party servers 350 have third party applications 352 stored therein.

### User Device

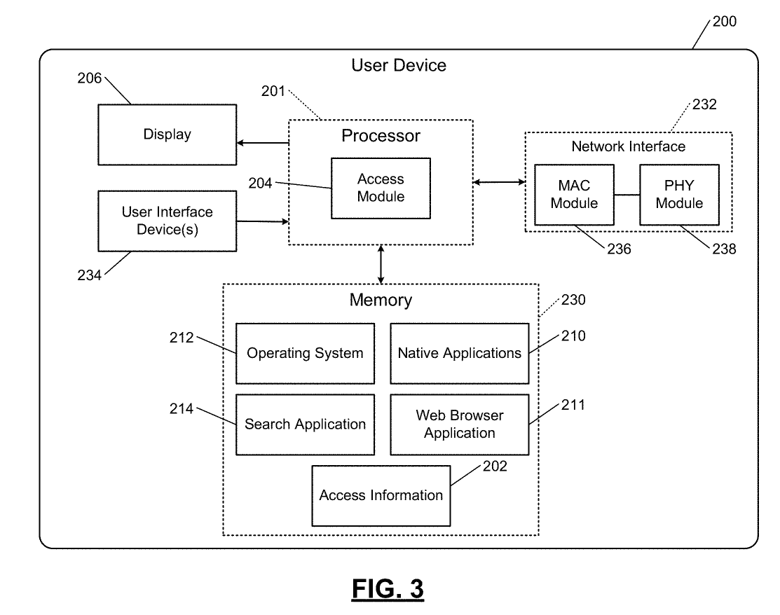

Referring now also to FIG. 3, which shows an example of any of the user devices 200. The User device 200 includes a processor 201, a display 206, a memory 230, a network interface 232, and user interface devices 234. The processor 201 includes an access module 204. The network interface 232 includes a medium access control (MAC) module 236 and a physical layer (PHY) module 238. The user device 200 may execute one or more software applications, such as native applications 210, a web browser application 211, a search application 214, which are stored in the memory 230. The user device also executes an operating system 212 also stored in the memory 230. The memory 230 may also store access information 202.

A software application may refer to computer software that, when executed by a computing device, causes the computing device to perform a task. In some examples, a software application is referred to as an “application”, an “app”, or a “program”. Example software applications include, but are not limited to, word processing applications, spreadsheet applications, messaging applications, media streaming applications, social networking applications, and games. In some examples, the applications 210 are installed on the user device 200 prior to a user 10 purchasing the user device 200. In other examples, the applications 210 may be downloaded and installed on the user device 200 subsequent to the user device 200 being purchased.

The user device 200 may execute different operating systems. If the user device 200 is a mobile device, the operating system 212 may be an ANDROID® developed by Google® Inc., informed operating system (IOS®) developed by Apple® Inc., or a WINDOWS PHONE® operating system developed by Microsoft® Corporation. If the user device 200 is a laptop or desktop computing device, then the operating system 212 may be a MICROSOFT WINDOWS® operating system by Microsoft Corporation, a MAC® operating system by Apple®, Inc., or a Linux® operating system. The user device 200 may also access and/or communicate with the search server 300 while running the operating system 212, which may be different than the above-stated operating systems.

The user device 200 may include multiple processors. In implementations when the user device 200 includes two or more processors, the processors can execute in a distributed or individual manner. The memory 230 may include random access memory (RAM), read-only memory (ROM), a hard disk drive and/or solid-state/flash memory) and store instructions executed on the processor 220. The memory 230 may store computer readable instructions that make up the native applications 210, the web browser application 211, and the operating system 212, and/or the search application 214. The operating system 212 is used to effectively provide an interface between the processor 220 and the applications 210, 211, 214.

The network interface 232 communicates with the search server 300 and other devices of the search system 100 via the modules 236, 238. The network interface 232 can include one or more transceivers for performing wired or wireless communication. The network interface 232 may include: one or more wireless and/or wire based transceivers, an Ethernet port, and/or a universal serial bus (USB) port. The user interface devices 234 include one or more devices configured to receive inputs from and/or provide content to the user 10. The user interface devices 234 may include, for example, a touchscreen (an example of which is shown in FIG. 3 as touchscreen 216), a display, a QWERTY keyboard, a numeric keypad, a touchpad, a microphone, speakers and/or other user interface devices. The user interface devices 234 may be used for user selections and receive at least one of a voice command, a touch gesture, or a click selection.

The user device 200 may communicate with the search server 300 using one or more of the native applications 210, which when executed transmit query wrappers 340 to the search server 300. In some examples, the user device 200 runs a native application that is dedicated to interfacing with the search server 300, such as a native application 210 dedicated to searches (i.e. a search application 214). In some examples, the user device 200 communicates with the search server 300 using a more general application 210, such as the web-browser application 211 accessed using a web browser.

The search server 300 performs search operations based on the search wrappers received to provide verticals (e.g., web pages, images, videos, informational data, applications, etc.). The search server 300 may be in communication with one or more of the third party servers 350. The third party servers 350 include the third party applications 352, which having corresponding app-specific functions that may be accessed by the user device 200 or the search server 300 via the distributed network 120.

The memory 320 may store one or more databases, indices (e.g., inverted indices), tables, files, and/or other data structures, which may be used to implement the techniques of the present disclosure. The memory 320 may also store application state records 430 and display component data 454. Referring now also to FIG. 4, which shows the user device 200 and the search server 300. The search module 310 receives a query wrapper 340 and performs a search for one of the application state records 430 stored in the memory 320 based on data included in a search query 342 of the query wrapper 340. The application state records 430 include access information 202 that the user device 200 uses to access different states and functions for the applications installed on the user device 200. The access information 202 may be stored in the memory 230 of the user device 200.

The access information 202 may include native, web access and/or download information. The user device 200 may use the access information 202 to access functionality of applications 210 via a uniform resource locator (URL). For example, the user 10 may select one of multiple display components 250 (examples of which are shown in FIG. 4), which corresponds to a link associated with access information in order to access functionality of an application 210 referenced by the access information. The access information includes data that the user device 200 uses to access functionality provided by a corresponding native application. The native application may be executed and set into a specified state based on the application access information. Accordingly, the process of launching the native application and performing function(s) according to the access information may be referred to herein as launching the native application and setting the native application into a state that is specified by the access information. For example, access information for a restaurant reservation application can include data that causes the user device 200 to launch the restaurant reservation application and assist in making a reservation at a restaurant. In such examples, the restaurant reservation application may be set in a state that displays reservation information to the user 10, such as a reservation time, a description of the restaurant, and user reviews.

The access information 202 may have different formats and content. The format and content of the access information may depend on (i) the native application with which the access information is associated, and (ii) the operations that are to be performed by the native application in response to selection of the access information. In general, a state of a native application may refer to the operations and/or the resulting outcome of the native application in response to selection of one of the display components 250. A state of a native application may also be referred to herein as an “application state.”

Web access information may include a resource identifier that includes a reference to a web resource (e.g., a page of a web application/website). For example, web access information may include a uniform resource locator (URL) (i.e., a web address) used with hypertext transfer protocol (HTTP). If the user 10 selects a display component corresponding to a link that includes web access information, the user device 200 may launch the web browser application 211 and retrieve a web resource indicated in a resource identifier. Put another way, if the user 10 selects a display component corresponding to a link that includes web access information, the user device 200 may launch a corresponding web-browser application and access a state (e.g., a page) of a web application/website. In some examples, web access information includes URLs for mobile-optimized sites and/or full sites.

The web access information included in an application state record 430 may be used by a web browser to access a web resource that includes similar information and/or performs similar functions as would be performed by one of the native applications 210. The one of the native applications 210 receives access information of the application state record 430. For example, the web access information of an application state record 430 may direct the web browser application 211 to a web version of the native application referenced in the access information of the application state record 430. If the access information included in an application state record 430, as an example, is for a specific Mexican restaurant, the access information causes each application edition to retrieve information for the specific Mexican restaurant. The web access information may direct the web browser application 211 to a web page entry for the specific Mexican restaurant.

Application download information may indicate a location (e.g., a digital distribution platform 130b) where a native application can be downloaded in the scenario where the native application 210 is not installed on the user device 200. If the user 10 selects a display component corresponding to a link that includes application information, the user device 200 may access a digital distribution platform from which the referenced native application may be downloaded. The user device 200 may access a digital distribution platform and/or the data storage devices 130 of FIG. 1 using at least one of the web browser applications 211 and one of the native applications 210.

The application state records 430 also include a function category 462 and a function tag 464. The function category 462 specifies a category of a function performed for a linked application state. The access information 202 is used to access a given function at the linked application state. The function tag 464 indicates the function that may be performed at the application state referred to by the access information 202. For example, the application state record 430 may be for a restaurant called GoodEats. The access information indicates. For example, an address to access the reservation system of GoodEats. The function tag 464 for this application state record 430 indicates a reservations function, and the function category 462 indicates a restaurants category. The search module 310 generates search results 440 based on the data included in the memory 320 and transmits the search results 440 to the user device 200. Access information is included in the search results 440. The function category 462 and function tag 464 may optionally be included in the search results 440. In some implementations, the search module 310 generates result scores 456 for the search results 440 identified during the search. The result score 456 associated with each search result 440 may indicate the relevance of the search result to the search query 342 (e.g., in order to rank each search result). A higher result score 456 may indicate that the search result is more relevant to the search query 342. The search module 310 may also retrieve access information for the scored search result. The search results 440 correspond to search result objects that are shown as display components, each including access information 202, display component data 454, and/or a result score 456. The display component data 454 and/or the result score 456 may be included in the search results 440.

Each search result object 260 includes display component data 454. The display component data 454 may be an image 262 (e.g., an icon), text 264 (e.g., an application or business name) that may describe an application, a state of the application, and/or other data. In the example shown, search result objects 260a-d are shown and each include images 262a-d and text 264a-d. The displayed search result objects 260 may include only images 262 or only text 264. Each of the search result objects 260 may include access information, such that when the user 10 selects a displayed result object, the user device 200 launches an associated one of the native applications 210 and sets the one of the native applications 210 into a state specified by the access information. In some examples, the user 10 selects a display component 250 and the user device 200 launches a corresponding software application (e.g., a native application or a web browser application) referenced by the access information and performs one or more operations indicated in the access information to enter an application state.

The search application 214 displays, on the screen 216 of the user device 200, a graphical user interface (GUI) 204 having a search field 206 and a search button 208. The user device 200 receives a search query 342 from the user 10 via the GUI 204. The search query 342 may be a request for information from the search server 300, and may include text, numbers, and/or symbols (e.g., punctuation). The user 10 may enter the search query 342 into the search field 206 and select the search button 208 to initiate execution of a search by the search server 300. The user 10 may enter a search query 342 using a touchscreen keypad, a mechanical keypad, a speech-to-text program, or other form of user input.

In response to receiving the search query 342, the user device 200 (e.g., via the search app 214) transmits a query wrapper 340, which includes the search query 342, to the search server 300 (e.g., to the search module 310). The query wrapper 340 may include additional data along with the search query 342. For example, the query wrapper 340 may include: geo-location data 344 that indicates a location of the user device 200, such as latitude and longitude coordinates from a global positioning system (GPS) receiver of the user device 200; an IP address 346 that the search module 310 may use to determine the location of the user device 200; and/or platform data 348 (e.g., a version of the operating system 212, a device type, and/or a web browser version). Additional information may include an identity of the user 10 of the user device 200 (e.g., a username), partner specific data, and/or other data.

In response to receiving the query wrapper 340, the search server 300 implements a search based on the search query 342 (included in the query wrapper 340) and generates search results 440. The search server 300 may retrieve data that is relevant to the search query 342 from one or more of the data storage devices 130 of FIG. 1. In some implementations, the search server 300 selects data including access information, a function category 462, and/or a function tag 464 based on matches between the search query 342 and application state record 430.

The data storage devices 130 of FIG. 1 may be sources that are accessed by the search module 310 of the search server 300. The search module 310 may access data stored in the data storage devices 130 and use the data to generate and update data stored in the memory 320. The data retrieved from the data storage devices 130 may include data related to application functionality and/or application states. Data retrieved from the data storage devices 130 may be used to create and/or update one or more databases, indices, tables (e.g., an access table), files, or other data structures included in the memory 320. For example, application state records 430 may be created and updated based on data retrieved from the data storage devices 130. Data included in the application state records 430 may be updated over time to assure that the search server 300 provides up-to-date search results.

The data storage devices 130 may correspond to different data providers. The data storage devices 130 may include data from application developers, such as application developer websites and data feeds provided by developers. The data storage devices 130 may include digital distribution platforms configured to distribute native applications to user devices 200. Example digital distribution platforms include, but are not limited to, the GOOGLE PLAY® digital distribution platform by Google®, Inc., the APP STORE® digital distribution platform by Apple®, Inc., and the WINDOWS PHONE® store developed by Microsoft® Corporation.

The data storage devices 130 may also store website data, such as website addresses of websites that include web logs (e.g., blogs), application review websites, or other websites including data related to applications. Additionally, the data storage devices 130 may also store data associated with social networking sites, such as “FACEBOOK®” by Facebook®, Inc. (e.g., Facebook® posts) and “TWITTER®” by Twitter Inc. (e.g., text from tweets). The data storage devices 130 may also include online databases that include data related to movies, television programs, music, restaurants, and/or other topics. The data storage devices 130 may also include additional types of data sources in addition to the data sources described above. The different data sources 130 may have respective content and update rates.

After generating/obtaining the search results 440, the search module 310 transmits search results 440 back to the user device 200, which renders the search results 440 (e.g., in a search engine results page, hereinafter SERP) on the screen 216 of the user device 200 as displayed search result objects 260. The search results 440 include the search result objects 260a-d. Each search result object 260 represents data for displaying a single search result. In some implementations, each of the search result objects 260 include access information, display component data for one or more display components, one or more function categories, one or more function tags and/or a result score. The result score indicates the relative rank of the displayed result object.

The user device 200 receives the search results 440 from the search server 300 and displays the search results 440 to the user 10 as the search result object 260. Each search result object 260 may correspond to a link associated with access information of the corresponding search result object. Moreover, the user device 200 may display each search result object 260 using the corresponding display component data 454. The user device 200 uses the display component data 454 to display one or more display components 250 associated the search results. Furthermore, the search application 214 or web browser application 211 may arrange the search result object 260 in an order based on result scores, function categories, and/or function tags included in the access information.

Based on the same example provided above, when the user 10 enters an ambiguous query term, the intent of the user 10 is unclear. For example, for a search query 342 of “sf giants,” the intent of the user 10 may be purchasing tickets to a San Francisco Giants game, reading or bookmarking reference articles about the Giants, buying or viewing products such as team memorabilia, or mapping or getting directions to locations related to the Giants. Accordingly, function tags for purchasing tickets and/or function categories for references, products and/or locations may be used to filter search results. In the example shown in FIG. 4, the user device 200 is executing a search for the query “barbecue.” The user 10 has selected the “filter” button 272 and has selected a function category for restaurants via button 272a.

Although buttons 272 are referred to herein, the buttons may be replaced with other user-selectable items, such as icons, boxes, or input fields, etc. The buttons may be provided as a checkable list located at the top of search result objects. The checkable list may be hidden initially and shown at a request by the user by, for example, tapping on an area of the screen 216 in a location of the checkable list. The search result objects 260 are for various apps (e.g., the native applications 210) each with a matching function category 462. In this example, selection of any one of the search result objects 260 may result in the corresponding application 210 being opened to the appropriate application state to allow the user 10 to have certain functions (e.g., viewing menus, reserving a table, etc.) related to the category “restaurant” performed. A shown page or window of the search results can include user-selectable tabs at a top of each category and user-selectable sub-tabs for each function associated with each category. In other examples, the user may touch a search result filter button for a predetermined period of time (i.e. “hold down” the button) to cause the access module 204 to bring up a menu that allows the user to select a “filter by category”, “filter by function” or a “filter by tag” options. The processor 201 and/or the processor 500 may then perform the corresponding filtering. In other examples, the user may touch a search result object and/or corresponding button for a predetermined period of time (i.e. “hold down” the button) to bring up a menu corresponding to the selected search result object and that allows the user to select a “filter by category”, “filter by function” or a “filter by tag” options corresponding to the search result object.

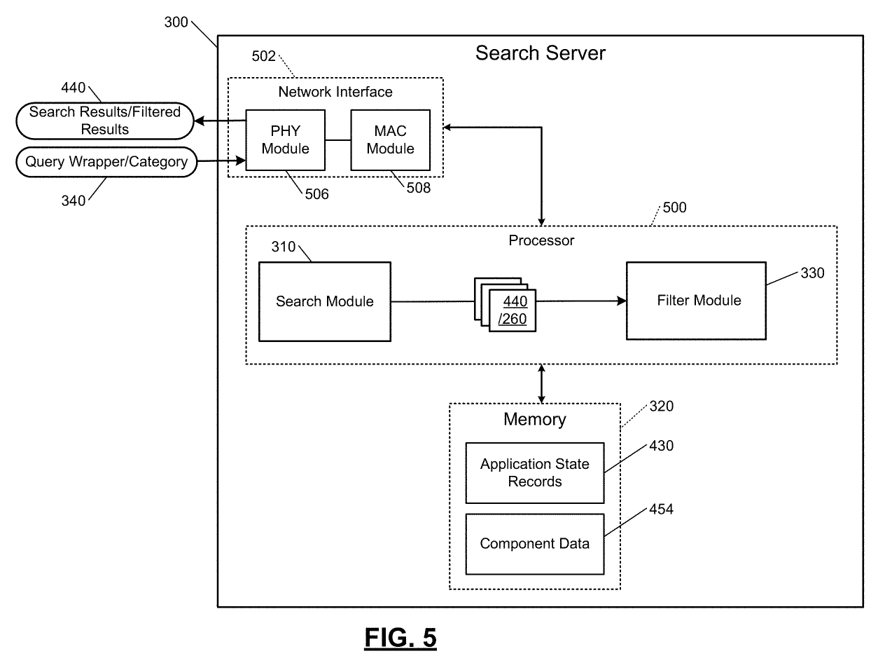

FIG. 5 illustrates an example of the search server 300 that receives a query wrapper 340 and outputs search results 440. The search server 300 includes a processor 500, the memory 320 and a network interface 502. The processor 500 includes the search module 310 and the filter module 330. The network interface 502 includes a PHY module 506 and a MAC module 508.

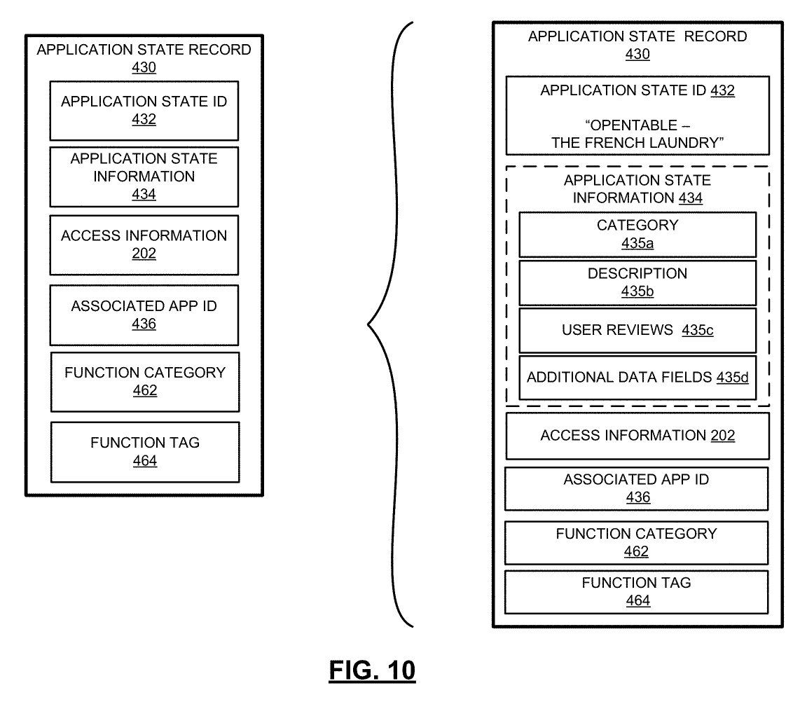

In some implementations, after receiving the query wrapper 340 at the search server 300, the search module 310 performs a search of the memory 320 based on a search query and/or the other data included in the query wrapper 340 and generates search result objects 260. Each search result object 260 is relevant to the search query and associated with a function category and/or a function tag. Search result objects may contain information from application state records 430 (e.g., access information, a function category, a function tag) together with display component data for rendering search result objects at the user device 200. Application state records 430 are further described with reference to FIG. 10. The filter module 330 may generate one or more filter links for filtering search results 440 based on function categories and/or function tags associated with the search result objects 260. Search result objects 260 together with the links associated with the buttons 272 may be sent to the user device 200 as search results 440. In some embodiments, the search module 310 and/or the filter module 330 are implemented at the user device 200, such that a search and filtering of the search results are performed locally at the user device 200.

### Functional Filtering

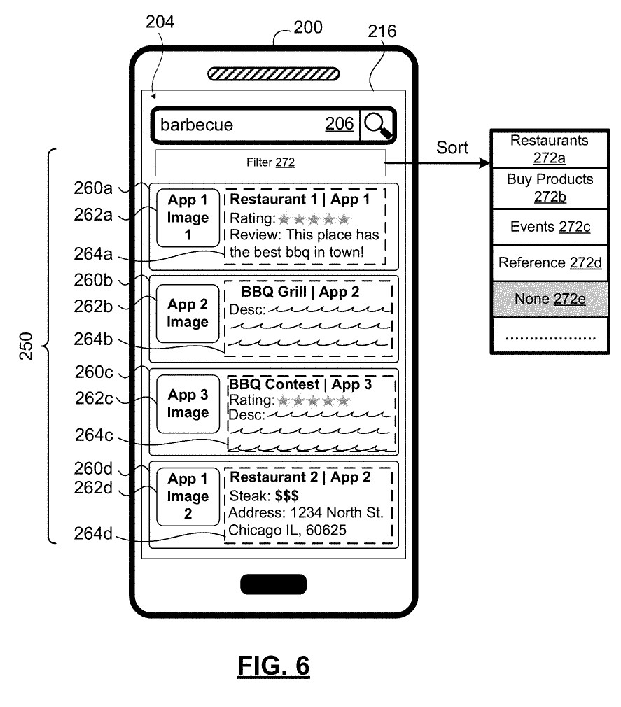

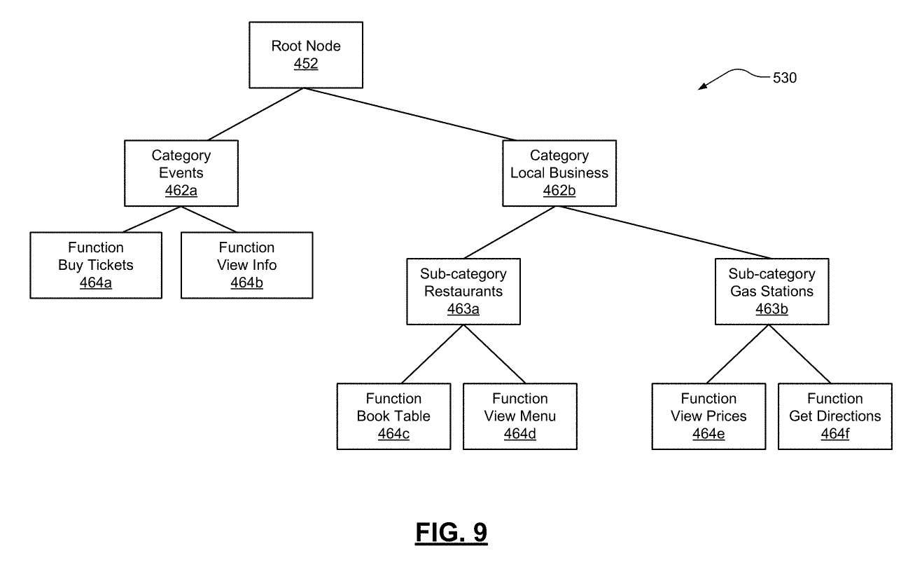

FIG. 6 shows an example of the user device 200 having a GUI 204 that facilitates functional filtering of search results 440. The user device 200 displays the search results 440 as search result objects 260a-d via the search application 214. The search result objects 260 may be filtered based on a selected function category, function tag and/or other information contained in the query wrapper 340. Each search result object 260 is selectable by the user 10 and has corresponding links and access information. When the user 10 selects one of the search result objects 260, the related access information is used to execute an application and/or access, for example, a webpage. This may include opening the associated application described in the application state record 430 and setting the associated application to an application state to access a corresponding function. Each of the search result objects 260 may be associated with multiple application state records, multiple function categories, and/or function tags. Accordingly, the user may select a category button, a function button, and/or a task button and the access module 204 may access the corresponding links via the search application 214. This may include accessing one or more links associated with filtering or sorting to filter and/or organize the search result objects 260, for example, based on a category or a function. If the displayed search result objects 260 are sorted by category or function, the search result objects 260 with the selected function categories or function tags are displayed higher in the list. In some examples, the sort order of the search result objects 260 is determined by a relatedness of the selected function or category to the function or category of each search result object 260 in a function tree as described below in FIG. 9. When the search results 440 are filtered, the search application 214 displays the search result objects 260 or some of the search result objects 260 that match the selected function categories and/or function tags.

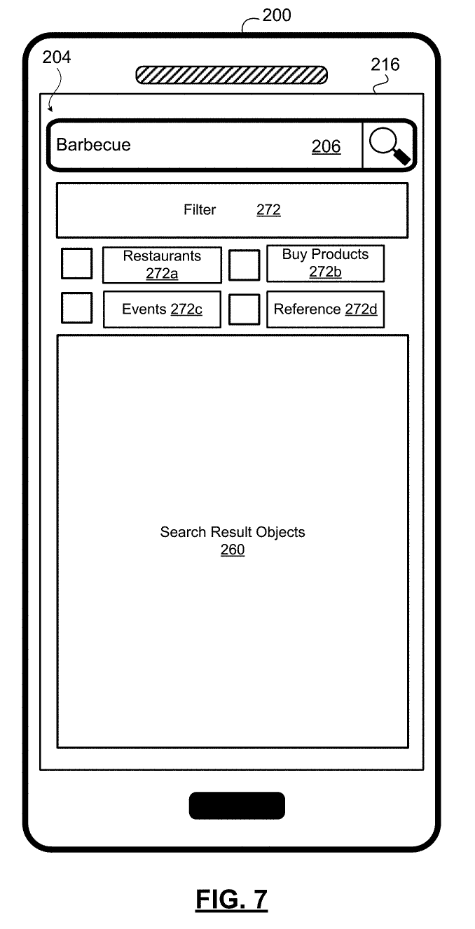

In the examples shown, the user 10 searched for “barbecue” and selected the filter button 272. In response to the user selection of the filter button 272, the search application 214 prompts the user 10 with some or all of the available function categories and/or function tags present in the search results 440 returned from the search server 300. The function categories and function tags displayed as buttons in the example of FIGS. 6-7 are “Restaurants” 272a, “Buy Products” 272b, “Events” 272c, “Reference” 272d, and “None” 272e. When the user 10 selects the “Restaurants” button 272a, the search result objects 260 are limited to display only search results 440 with function category “Restaurants”. A selection of the search result objects 260 for the function category “Restaurants” takes the user 10 to a web page or application state with functions related to restaurants (e.g., booking tables, viewing menus, etc.). When the user 10 selects the “Buy Products” button 272b, the search result objects 260 are limited to display only search results 440 with function tag “Buy Products”. A selection of the search result objects 260 for the function tag “Buy Products” takes the user 10 to an application state or web page to purchase the products using the access information 202. When the user 10 selects the “Events” button 272c, the search result objects 260 are limited to display only search results 440 for function category “Events”. A selection of the search result objects 260 for the function category “Events” takes the user 10 to an application 210 or web page to view functions related to events (e.g., buying tickets, getting directions, etc.). When the user 10 selects the “Reference” button 272d, the search result objects 260 are limited to display only search results 440 for function category “Reference”. A selection of the search result objects 260 for the function category “Reference” takes the user 10 to an application 210 or web page to view functions related to reference (e.g., viewing articles, subscribing to blogs, etc.). When the user 10 selects the “None” button 272e, the search result objects 260 are restored to the full original search results 440 returned from the search server 300. Multiple buttons may be selected at a time to allow for multiple function categories and/or function tags to be displayed.

FIG. 7 shows an example of the user device 200 having a GUI 204 that facilitates functional filtering of search results 440 and/or search result objects 260. The filter button 272 may allow the user 10 to select the function categories and/or function tags to be displayed. In the example shown, the user 10 searched for “barbecue” and selected the filter button 272. In response to the user selection of the filter button 272, the search application 214 prompts the user 10 with some or all of the available function categories 462 and/or function tags 464 present in the search results 440 returned from the search server 300 relevant to the search query 342 “barbecue”. Checkboxes or other forms of user-interface components may be included, as shown, to allow multiple selections to be made by the user 10. The search application 214 also prompts the user 10 with some or all of the available function categories and/or function tags present in the search results 440 returned from the search server 300. The function categories and/or function tags displayed in this example are the “Restaurants” button 272a, the “Buy Products” button 272b, the “Events” button 272c, and the “Reference” button 272d. These buttons 272, 272a-d function similarly as described with reference to FIG. 6.

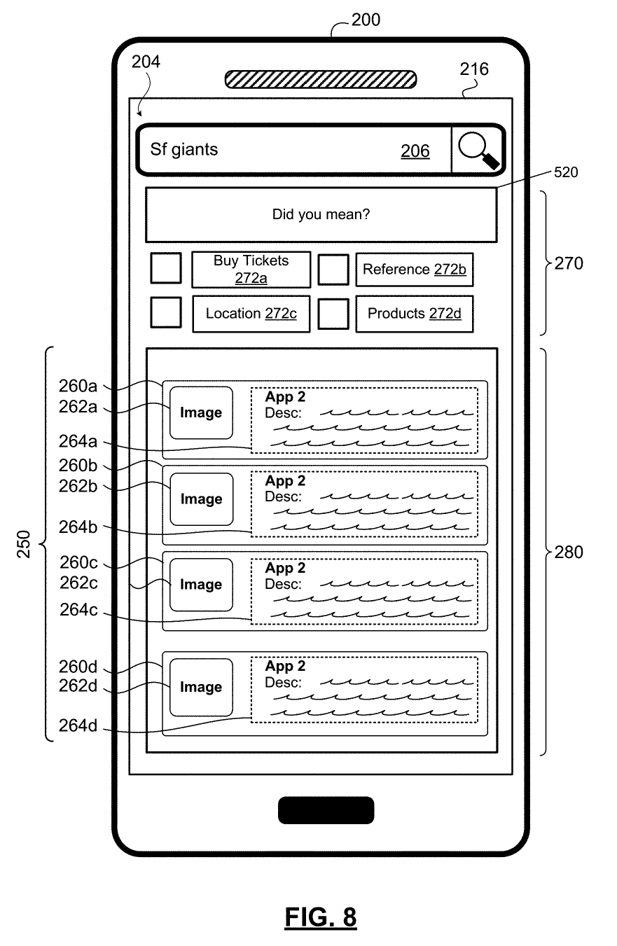

FIG. 8 shows an example of the user device 200 having a GUI 204 that facilitates functional filtering of search results 440 and/or search result objects 260. The user device 200 displays on the screen 216 a filter portion 270 and a result portion 280. The filter portion 270 contains the buttons 272 for certain function categories and/or function tags represented in the search results 440. The filter portion 270 may include a questionnaire section and/or a box (e.g., box 520 is shown) including one or more questions for the user to aid in disambiguating the query entered. An example question “Did you mean?” is shown in box 520. Other questions may be asked and the search results may be filtered and/or sorted based on the answers received from the user. The result portion 280 contains the user-selectable buttons 272 that each correspond to one or more of the search result objects 260 of the search results 440. Each of the user-selectable buttons 272 correspond to a function category and/or a function tag.

In the example shown, the user 10 searched for “Sf giants.” The search application 214 prompts the user 10 with some or all of the available function categories and/or function tags present in the search results 440 returned from the search server 300. Checkboxes or other forms of user input may be included to allow multiple selections to be made by the user 10. The function categories and/or function tags displayed in this example are a “Buy Tickets” button 272a, a “Reference” button 272b, a “Location” button 272c, and a “Products” button 272d. The function categories and/or function tags presented may be drawn from the application state records 430 associated with the search, “sf giants.” Each of the function categories and/or function tags presented may help the user select the function that the user 10 wants to perform.

Referring now to FIG. 4 and FIG. 9, which shows a portion of an example function relation tree 530 having a root node 552 from which function categories 462a-b (collectively 462) are connected. In some embodiments, function categories 462 comprise sub-categories 463, which may each further include additional sub-categories (not shown), etc. Each function category has one or more function tags 464. Each function category 462 thus contains (optional) related function sub-categories 463 as well as function tags 464. Application state records 430 may be assigned a function category 462, a function sub-category 463 and/or function tag 464. The function relation tree 530 may be arranged in order from most generic filter (i.e., the root node 552 which corresponds to every category and tag) to most specific (i.e., function tags 464). Function categories 462 are considered more generic than function tags 464. Function sub-categories 463 are considered more specific than function categories 462.

Function categories 462 may be automatically assigned to application state records 430 using the function relation tree based on the function tag assigned to each application state record 430. For example, an application state record 430 corresponding to a “Buy Tickets” function 464a may be automatically assigned a function category “Events” 462a using the function tree. Application state records 430 may be assigned function tags 464 manually or using automated methods. In some embodiments, application state records 430 may be assigned multiple categories (e.g., an application state record 430 assigned function tag 464c may be assigned function categories “Local Business” 462b and “Restaurants” 462c). In some embodiments, a function tag is associated with two or more function categories and/or sub-categories.

The related function categories 462 may be used to provide disambiguation for a search query 342 that corresponds to multiple function sub-categories or function tags. For example, search results 440 for “sf giants” may include a set of search results with function tags “Buy Tickets” 464a and “View Info” 464b. Each such search result may also contain the function category “Events” 462a. In such an example, filter module 330 may generate a function category filter for “Events” rather than function tag filters for “Buy Tickets” and “View Info.” In some embodiments, filter module 330 may generate filters for the function tags 464 and/or function categories 462 that appear most often in all search results. In other embodiments, filter module 330 may generate filters for the function tags 464 and/or function categories 462 that appear most often in the top X (e.g., 50) number of search results. Additionally, counts can be weighted by multiplying result scores 456 by counts of function tags 464 and/or function categories 462, such that filters are biased to the highest scoring results.

In another example, search result objects 260 for “barbecue” may include a set of search results with function tags “Book Table” 464c and “View Menu” 464d. Each such search result may also contain function categories “Restaurants” 462c and “Local Business” 462b. In this example, there are no search results with function tags 464 that fall under the category “Gas Station” 462d. Therefore, the filter module 330 may filter to function category “Restaurants” 462c rather than “Local Business” 462b. In general, when multiple related function categories 462 and/or function tags 464 appear at relatively similar frequencies in the search results, filter module 330 generates buttons 272 that are more specific and narrows the filtering to more corresponding function categories 462 or function tags 464 that are further from the root node 452. In this example, filter module 330 selects “Restaurants” category 462c because it appears as frequently as “Local Business” category 462b, but is more specific.

However, filter module 330 may generate buttons 272 for more specific function categories 462 and/or tags 464 that appear less often, yet within threshold differences, of more generic function categories 462. For example, if result objects 450 contain 78 results tagged with function tag “Buy Tickets” 464a and 80 results tagged with function category “Events” 462a, the filter module 330 may generate a “Buy Tickets” button rather than an “Events” button. Threshold differences may be expressed as absolute numbers (e.g., the filter module 330 may filter based on a function tag if a function tag appears in up to 10 fewer search results than a function category). Threshold differences may also or alternatively be expressed as percentage differences (e.g., the filter module 330 may filter based on a function sub-category if a function sub-category appears in up to 5% fewer search results than a function category).

In some embodiments, the filter module 330 may remove search result objects that do not match the selected function category 462 and/or function tag 464 from the GUI 204. In other embodiments, the filter module 330 re-sorts search result objects using the function tree. In these embodiments, search result objects matching the selected function category 462 and/or function tag 464 may be ranked before other search result objects. Search results objects that do not match the selected function category 462 and/or function tag 464 may be re-sorted in order of proximity to the selected function category 462 and/or function tag 464. For example, if the filter module 330 selects the function category “Restaurants” 462c, then search result objects that match “Local Business” 462b but not “Restaurants” 462c may be ranked next, because the search result objects contain a matching category one node away from the selected filter on the function relation tree 530. Next, search result objects that match the function category “Events” 462a may be ranked next because the search result objects are the next closest results on the function relation tree. Re-sorting may involve assigning boosts or penalties to result scores based on proximity on the function relation tree for the selected button. Alternately, the filtering may involve assigning maximum or minimum result scores to different groups of search result objects based on proximity of each group on the function relation tree to the selected button.

In some embodiments, the filter module 330 may be located at the user device 200 (e.g., as a component of search application 214). The filter module 330 may generate filters at run-time after receiving search result objects from the search server 300. If the search server 300 provides search result objects asynchronously or in batches, the filter module 330 may generate an initial set of buttons for an initial set of search result objects. The filter module 330 may then generate updated buttons based on an updated set of search result objects. For example, after sending a search query to the search server 300, the user device 200 may initially receive the top 20 search result objects (e.g., by result score) and generate buttons therefrom. Subsequently, a user of user device 200 may scroll the SERP (or access a second page of the SERP, etc.) to request retrieval of additional search results, whereupon a second set of buttons may be generated taking into account all of the received search result objects.

The filter module 330 may generate additional buttons for display in GUI 204 after selection of a button. For example, if a user selects a button for a “Local Business” category, the search results may be filtered to those within the local business category. Subsequently, additional buttons for function categories and/or function tags associated with the “Local Business” category may be displayed for the filtered set of search results in the same manner described above. In other words, the selected “Local Business” category may be treated as the new root node and additional filtering may be performed using the portion of the function relation tree 530 beginning at the “Local Business” category in order to further narrow the set of search results. Such additional filters 272 may be generated based on the initial set of buttons (i.e., assuming that a user will select one of the initial buttons), or may be generated after a user selects a displayed button. Each of the above-described buttons may be referred to as filtering buttons and corresponding to filtering based on a portion of the function relation tree 530.

### Application State Records

Referring to FIG. 4 and FIG. 10, which shows an example application state record 430. The memory 320 stores application state records 430 corresponding to application states. An application state record 430 may include an application state identifier (ID) 432, application state information 434, an application identifier (ID) 446, one or more function categories 462, one or more function tags 464, and access information 202 used to access functionality provided by an application (e.g., one of the native applications 210). The function category 462 may be data that can be used to identify the function category of the application state described in the application state record 430. The function tag 464 may be data that can be used to identify the function tag of the application state described in the application state record 430. The access information 202 facilitates access to a given state of an application 210 on the user device 200.

The search server 300 may use the application state ID 432 to identify the application state record 430 among the other application state records 430 included in the memory 320. The application state ID 432 may be a string of alphabetic, numeric, and/or symbolic characters (e.g., punctuation marks) that uniquely identifies the associated application state record 430. In some examples, the application state ID 432 describes a function and/or an application state in human readable form. For example, the application state ID 432 may include the name of the application referenced in the access information 202. In a specific example, an application state ID 432 for an internet music player application may include the name of the internet music player application along with the song name that may be played when the internet music player application is set into the state defined by the application information. In some examples, the application state ID 432 includes a string in the format of a uniform resource locator (URL) of web access information, which may uniquely identify the application state record 430. In additional examples, the string includes multiple parameters used to retrieve the corresponding application state record 430. Moreover, some parameters may be user-generated, which means that the parameters put the application in a new application state record 430 that has not been previously executed. Thus, the user-selectable button may not explicitly correspond to a known end result inside the application, but simply fits a known link expression that the application accepts. For example, the UBER® application may display a user-selectable button when clicked causes the UBER® application to use a latitude and longitude as a parameter to determine location.

In another example, if the application state record 430 describes a function of the YELP® native application, the application state ID 432 may include the name “Yelp” along with a description of the application state described in the application state information 434. For example, the application state ID 432 for an application state record 430 that describes the restaurant named “The French Laundry” may be “Yelp—The French Laundry.” In an example where the application state ID 432 includes a string in the format of a URL, the application state ID 432 may include the following string “http://www.yelp.com/biz/the-french-laundry-yountville-2?ob=1” to uniquely identify the application state record 430. In additional examples, the application state ID 432 may include a URL using a namespace other than “http://,” such as “func://,” which may indicate that the URL is being used as an application state ID in an application state. For example, the application state ID 432 may include the following string “func://www.yelp.com/biz/the-french-laundry-yountville-2?ob=1.”

The application state information 434 may include data that describes an application state into which an application is set according to the access information 202 in the application state record 430. Additionally or alternatively, the application state information 434 includes data that describes the function performed according to the access information 202 included in the application state record 430. The application state information 434 may include text, numbers, and symbols that describe the application state. The types of data included in the application state information 434 may depend on the type of information associated with the application state and the functionality specified by the access information 202. The application state information 434 may include a variety of different types of data, such as structured, semi-structured, and/or unstructured data.

In some examples, the application state information 434 includes data that is presented to the user 10 by an application when the application 210 is set in the application state specified by the access information 202. For example, the application state information 434 may include data that describes a state of the native application after the user device 200 has performed the one or more operations indicated in the application access information 202. In a specific example, if the application state record 430 is associated with a shopping application, the application state information 434 may include data that describes products (e.g., names and prices) that are shown when the shopping application is set to the application state specified by the access information 202. As another example, if the application state record 430 is associated with a music player application, the application state information 434 may include data that describes a song (e.g., name and artist) that is played when the music player application is set to the application state specified by the access information 202.

The types of data included in the application state information 434 may depend on the type of information associated with the application state specified by the access information 202. For example, if the application state record 430 is for an application 210 that provides reviews of restaurants, the application state information 434 may include information (e.g., text and numbers) related to a restaurant, such as a category of the restaurant, reviews of the restaurant, and a menu for the restaurant. In this example, the access information 202 may cause the application 210 (e.g., a native application or a web browser application) to launch and retrieve information relating to the restaurant. As another example, if the application state record 430 is for an application 210 that plays music, the application state information 434 may include information relating to a song, such as the name of the song, the artist, lyrics, and listener reviews. In this example, the access information 202 may cause the application to launch and play the song described in the application state information 434.

The search server 300 may use the application ID 446 to identify a native application 210 associated with the application state record 430. The application ID 446 may be a string of alphabetic, numeric, and/or symbolic characters (e.g., punctuation marks) that uniquely identifies the associated native application. In some examples, the application ID 446 is the native application in human readable form. For example, the application ID 446 may include the name of the application referenced in the access information 202.

The application state record 430 may be associated with the OPENTABLE® application, developed by OPENTABLE®, Inc. The OPENTABLE® application is a restaurant-reservation application that allows users 10 to search for restaurants and make restaurant reservations. The OPENTABLE® application provides information about restaurants including descriptions of restaurants and user reviews of the restaurants. The example application state record 430 may describe an application state of the OPENTABLE® application in which the OPENTABLE® application accesses information for THE FRENCH LAUNDRY® restaurant.

The example application state record 430 includes an application state ID 432 of “OPENTABLE—THE FRENCH LAUNDRY,” which may be used as a unique identifier to identify the application state record 430. In other examples, the application state ID 432 includes a URL as a unique identifier for the application state record 430. For example, the application state ID 432 may include the string “http://www.opentable.com/the-french-laundry” as a unique identifier for the application state record 430, or may include “func://” as a namespace, as described above.

The example application state information 434 includes data fields 435, such as a category 435a of THE FRENCH LAUNDRY® restaurant, a description 435b of THE FRENCH LAUNDRY® restaurant, user reviews 435c of THE FRENCH LAUNDRY® restaurant, and additional data fields 435. The restaurant category 435a field may include the text “French cuisine” and “contemporary,” for this example. The description field 435b may include text that describes THE FRENCH LAUNDRY® restaurant. The user reviews field 435c may include text of user reviews for THE FRENCH LAUNDRY® restaurant. The additional data fields 435 may include additional data for THE FRENCH LAUNDRY® restaurant that may not specifically fit within the other defined fields, such as a menu for the restaurant, prices, and operating hours for the restaurant.

The access information 202 may include a reference to the OPENTABLE® application. As an example, the access information 202 may include a reference to the OPENTABLE® native application along with one or more operations to be performed by the user device 200. For example, the access information 202 may include an application resource identifier and/or one or more operations that cause the user device 200 to access the entry for THE FRENCH LAUNDRY® restaurant in the OPENTABLE® native application. An example application resource identifier may be “vnd.opentable.deeplink://opentable.com/restaurant/profile?rid=1180&refid=1.”

In some implementations, the access information 202 may include edition information that indicates the application edition with which the access information 202 is compatible. For example, the edition information indicates the operating system 224 with which the access information 202 is compatible. Moreover, different access information 202 may be associated with different editions of a native application. A native application edition (hereinafter “application edition”) refers to a particular implementation or variation of a native application. For example, an application edition may refer to a version of a native application, such as a version 1.0 of a native application 210 or a version 2.0 of a native application. In another example, an application edition may refer to an implementation of a native application for a specific platform, such as a specific operating system.

The different access information 202 included in an application state record 430 may cause the corresponding application editions to launch and perform similar functions. Accordingly, the different access information 202 may cause the corresponding application editions to be set into similar application states. For example, if the different access information 202 reference different editions of an information retrieval application, the different access information 202 may cause the corresponding application editions to retrieve similar information. In another example, if the different access information 202 reference different editions of an internet music player application, the different access information 202 may cause the corresponding application editions to play the same song.

In some examples, an application state record 430 for a native application that retrieves restaurant information includes multiple different access information 202 for multiple different application editions. Assuming the application state record 430 is associated with a specific Mexican restaurant, the access information 202 for the different application editions may cause each application edition to retrieve information for the same specific Mexican restaurant. For example, first access information may result in a first application edition (e.g., on a first operating system) to retrieve information for the specific Mexican restaurant. Second access information may result in a second application edition (e.g., on a second operating system) to retrieve information for the specific Mexican restaurant.

### Filtering Search Results

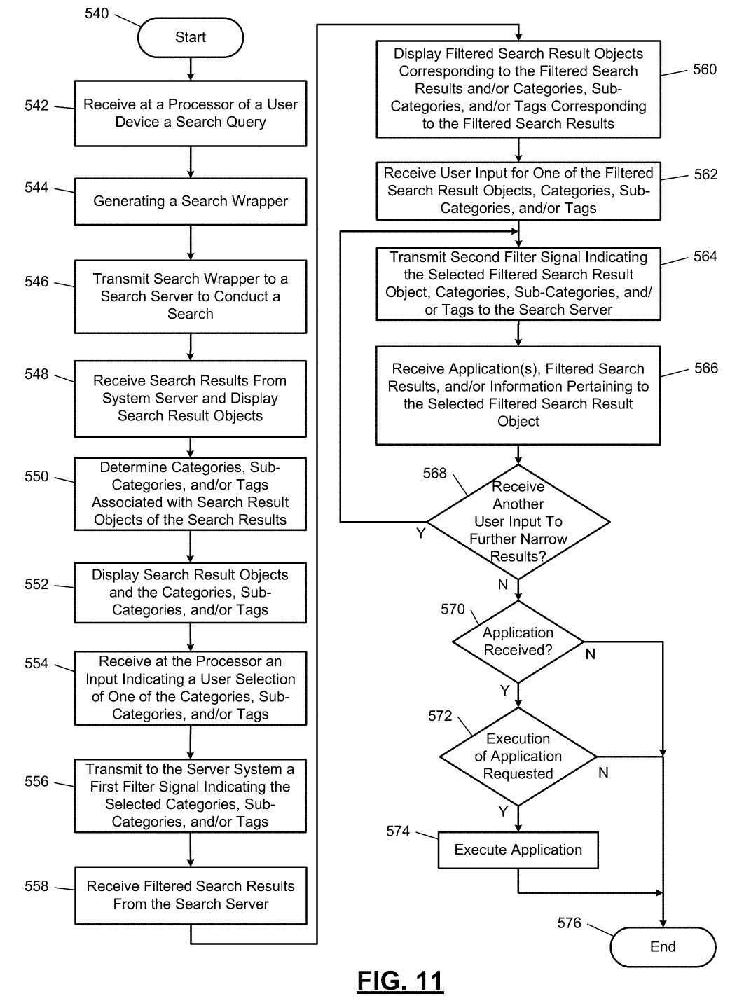

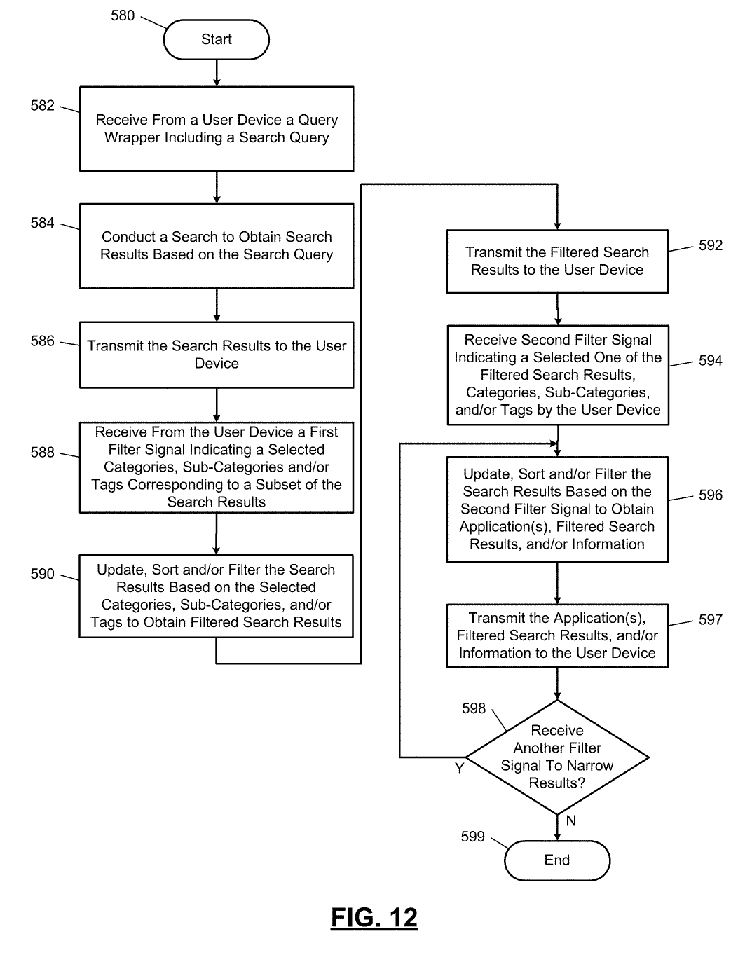

For further defined structure of the devices, servers, processors and modules of FIGS. 1-8 see below provided methods of FIGS. 11-12 and below provided definition for the term “module”. The following operations include filtering search results based on function categories and/or function tags. Multiple filtering operations (or narrowing of search results) may be performed.

The systems disclosed herein may be operated using numerous methods, example methods are illustrated in FIGS. 11-12. In FIG. 11, a user device method for performing a categorical search is shown. Although the following methods are shown as separate methods, the method of FIG. 11 may be performed while the method of FIG. 12 is performed. Although the methods of FIGS. 11-12 are described with respect to the modules 310 and 330 being located at the search server 300, the methods may be modified for when the modules 310, 330 are implemented at the user device. When implemented at the user device 200, the modules 310, 330 may be separate from the processor 201 or implemented in the processor 201. Operations of the modules 310, 330 may be executed by the processor 201. The modules 310, 330 may communicate with the access module 204. The searches that are performed may be conducted by the search module 310 at the user device 200 or may be conducted by the search server 300, which may then provide the search results to the search module 310.

Although the following operations are primarily described with respect to the implementations of FIGS. 1-8, the operations may be modified to apply to other implementations of the present disclosure. The operations may be iteratively performed. The method may begin at 540.

At 542, the access module 204 of the user device 200 receives a search query from a user via the user interface devices 234. The search query 342 includes data (or characters) to be searched by the search server 300. At 544, the access module 204 generates a search wrapper (e.g., the query wrapper 340). At 546, the access module 204 transmits the query wrapper, via the network interface 232, to the search server 300 to have a search performed.

At 548, the access module 204 receives search results from the search module 310 based on the information contained in the query wrapper and displays search result objects correspond to the search results. The results may be referred to as “deep” search results, where each search result includes: a function URL; an access URL; an application ID associated with the query; content; and/or a category and/or a tag linked to the content. The access module 204 may display on the screen 216 the search result objects as selectable buttons for the user to select and/or other user-selectable buttons corresponding to the search result objects. Each search result may include access information having a reference to an application executable on the processor 201 and indicating a performable operation for one of the applications 210. The application is to enter an operating state providing content related to the search query. Each of the search results may also include a function category and/or a function tag indicating one or more application functions of the application 210.

At 550, the access module 204 determined categories, sub-categories and/or tags associated with the search result objects included in and/or associated with the search results. At 552, the access module 204 displays via the display 206 one or more of the categories, sub-categories and/or tags as user-selectable buttons. The access module 204 displays on the screen 216 a user-selectable buttons for function tags 464 and/or function categories 462 represented in the search results 440.

At 554, the access module 204 receives via the user interface devices 234 an input indicating a user selection of one of the user-selectable buttons. The user 10 may select a function category 462 or function tag 464, and the access module 204 then limits the displayed search results to the search results 440 that include and/or are related to the function category 462 or function tag 464. In some examples, the selection by the user 10 limits the displayed results to a combination of function tags 464 and function categories 462.

At 556, the access module 204 generates a first filter signal indicating the one or more selected categories, sub-categories, tags and/or corresponding links and transmits the first filter signal to the search server 300. At 558, the access module 204 receives filtered search results from the system server. The filtered search results may be a subset of the search results provided at 548 and/or may indicate the ones of the search results provided at 548 that should be removed (or no longer displayed). The filtered search results may be sorted as described above.

At 560, the access module 204 displays the filtered search result objects corresponding to the filtered search results and/or buttons for categories, sub-categories and/or tags corresponding to the filtered search results. This may include ceasing to display search result objects that do not correspond to the filtered search results and/or ceasing to display categories, sub-categories and/or tags that are not associated with the filtered search results.

In some examples, the access module 204 sorts or groups the user-selectable search result objects based on the corresponding function category and/or function tag. The access module 204 may sort or group the user-selectable search result objects for the category subset of the search results. In some examples, the access module 204 displays on the screen 216, the result portion 280 containing the user-selectable search result objects for each search result and the filter portion 270 including the user-selectable buttons for function categories and/or function tags. In some examples, the result portion 280 and the filter portion 270 are each independently collapsible/expandable.

At 562, the access module 204 may receive a user input for one of the filtered search results or selection of one or more buttons associated with the categories, sub-categories, and/or tags provided in the filtered search results. In some examples, a menu selection is received indicating selection of a user-selectable search result object by a user interaction associated with opening a menu and displaying the menu on the screen 216. The menu includes the user-selectable buttons for the corresponding search results or search result objects. The user interaction may include a long press or double tap on the screen 216. In some examples, a search result selection is made and in response to the received search result selection, the access module 204 executes operations based on the access information of the corresponding search result and/or search result object and/or executes an application corresponding to the access information.

At 564, the access module 204 generates and transmits a second filter signal indicating the selected filter result object, categories, sub-categories, tags and/or corresponding links to the search server 300. At 566, the access module 204 receives one or more applications, filtered search results, and/or information pertaining to the selected filtered search result object, the selected categories, sub-categories, and/or tags.

At 568, the access module 204 determines whether another user input/selection has been received to further narrow the search results. If another input/selection has been received, task 574 may be performed; otherwise task 570 may be performed. At 570, the access module 204 determines whether application has been received. If application has been received, task 572 is performed; otherwise the method may end at 576.

At 572, the access module 204 determines whether a user input has been received to execute the application. If an input is received to execute the application, task 574 is performed and the access module 204 and/or the processor 201 executes the application. Otherwise, the method end at 576 subsequent to performing task 572.

The above-described operations are meant to be illustrative examples; the operations may be performed sequentially, synchronously, simultaneously, continuously, during overlapping time periods or in a different order depending upon the application. Also, any of the operations may not be performed or skipped depending on the implementation and/or sequence of events.

FIG. 12 shows a search server method for performing a categorical search. The method may begin at 580. At 582, the search module 310 receives, via the network interface 232, from the access module 204 the query wrapper including a search query.

At 584, the search module 310 performs a search based on the information in the query wrapper to provide search results. The search server 300 accesses the memory 320 and application state records 430, via the search module 310, to generate the search results 440, for example, based on application state records 430 relevant to the search query 342. The application state records 430 that are determined to match the related search results 440 may include one or more of the function category 462 and/or the function tag 464. The function categories 462 and function tags 464 may be determined from the application state record 430 stored in the memory 320. The search results 440 may also include search result objects 260, access information 202, display component data 454, and/or result scores 456.

At 586, the search module 310, via the network interface 232, transmits the search results to the access module 204. The search module 310 may send the search result objects associated with the search results to the filter module 330. At 588, the filter module 330 receives from the access module 204 the first filtered signal indicating one or more selected categories, sub-categories, and/or tags corresponding to a subset of the search results.

At 590, the filter module 330 updates, sorts and/or filters the search results based on the contents of the first filter signal to obtain filtered search results. At 592, the filter module 330 transmits the filtered search results to the access module 204.

At 594, the filter module 330 receives the second filter signal indicating a selected one of the filtered search results and/or one or more selected categories, sub-categories, tags and/or corresponding links from the access module 204. At 596, the filter module 330 may update, sort, and/or filter search results based on the contents of the second filter signal to obtain one or more applications, filtered search results, and/or information.

At 597, the filter module 330 transmits the one or more applications, filtered search results, and/or information to the access module 204. At 598, the filter module 330 determines whether another filter signal has been received to further narrow the search results. If another filter signal has been received, task 596 may be performed; otherwise the method may end at 599.

The above-described operations are meant to be illustrative examples; the operations may be performed sequentially, synchronously, simultaneously, continuously, during overlapping time periods or in a different order depending upon the application. Also, any of the operations may not be performed or skipped depending on the implementation and/or sequence of events.

### Computing Devices

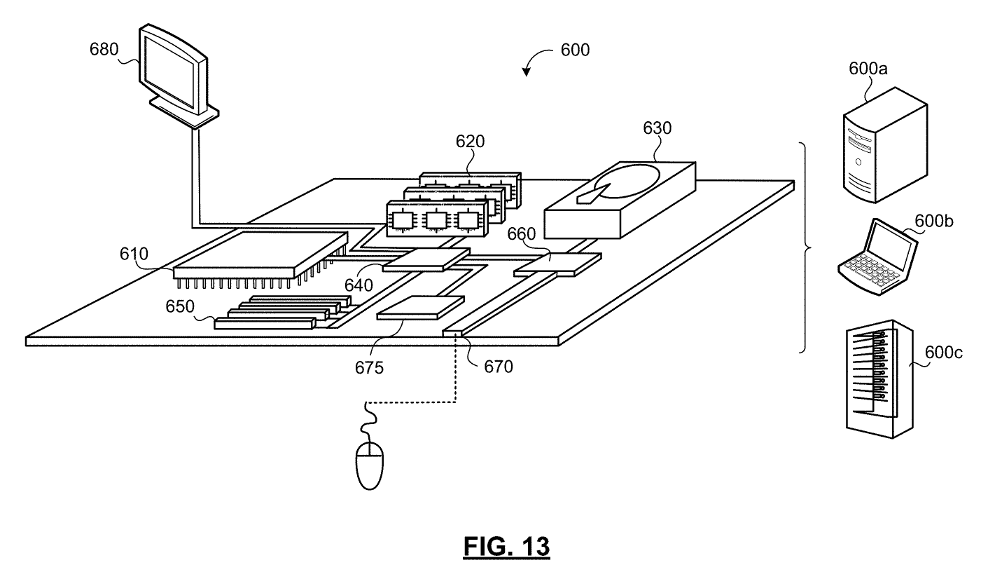

FIG. 13 shows an example computing device 600 that may be representative of the structure of the user device 200 and/or the search server 300 of FIGS. 1-4. The computing device 600 may be a laptop, a desktop, a workstation, a personal digital assistant, a server, a blade server, a mainframe, or other appropriate computer. The computing device 600 may be implemented as a standard server 600a or multiple times in a group of such servers 600a, as a laptop computer 600b, or as part of a rack server system 600c.

The computing device 600 includes a processor 610, memory 620, a storage device 630, a high-speed interface/controller 640 connecting to the memory 620 and high-speed expansion ports 650, and a low speed interface/controller 660 connecting to low-speed expansion port 670 and storage device 630. The computing device 600 may also include a network interface 675. Each of the components 610, 620, 630, 640, 650, 660, 675, are interconnected using various busses, and may be mounted on a substrate or a motherboard. The processor 610 can process instructions for execution within the computing device 600, including instructions stored in the memory 620 or on the storage device 630 to display graphical information for a GUI on an external input/output device, such as display 680 coupled to high-speed interface 640. Also, multiple computing devices 600 may be connected, where each device provides portions of the necessary operations (e.g., as a server bank, a group of blade servers, or a multi-processor system).

The memory 620 stores information non-transitorily within the computing device 600. The memory 620 may be a computer-readable medium and include volatile memory and/or non-volatile memory. The non-transitory memory 620 may store programs (e.g., sequences of instructions) and/or data (e.g., program state information) on a temporary or permanent basis. Examples of non-volatile memory include flash memory and read-only memory (ROM), programmable read-only memory (PROM), erasable programmable read-only memory (EPROM), and electronically erasable programmable read-only memory (EEPROM), which may be used for firmware, such as boot programs. Examples of volatile memory include random access memory (RAM), dynamic random access memory (DRAM), static random access memory (SRAM), phase change memory (PCM).

The storage device 630 provides mass storage and is a computer-readable medium. The storage device 630 may be a floppy disk device, a hard disk device, an optical disk device, a tape device, a flash memory, a solid-state memory device, or an array of devices, including devices in a storage area network. In additional implementations, a computer program product is tangibly embodied in an information carrier. The computer program product contains instructions that, when executed, perform one or more methods including the methods disclosed herein. The information carrier is a computer or machine-readable medium, such as the memory 620, the storage device 630, or memory on processor 610.

The high-speed controller 640 manages bandwidth-intensive operations while the low speed controller 660 manages lower bandwidth-intensive operations. Such allocation of duties is exemplary only. In some implementations, the high-speed controller 640 is coupled to the memory 620, the display 680 (e.g., through a graphics processor or accelerator), and to the high-speed expansion ports 650, which may accept various expansion cards (not shown). In some implementations, the low-speed controller 660 is coupled to the storage device 630 and low-speed expansion port 670. The low-speed expansion port 670 may include various communication ports (e.g., USB, Bluetooth®, Ethernet, wireless Ethernet) and may be coupled to one or more input/output devices, such as a keyboard, a pointing device, a scanner, and/or a networking device (e.g., a switch or router) via a network adapter.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. §112(f) unless an element is expressly recited using the phrase “means for” or, in the case of a method claim, using the phrases “operation for” or “step for.”

What is claimed is:

1. A method comprising:
receiving at a processor of a user device a search query for an application;
obtaining at the processor search results based on the search query, wherein each of the search results comprises:
access information including a reference to an application executable on the processor and indicating an operation for the application to enter an operating state, wherein the application provides content related to the search query while in the operating state,
a category, and
a tag indicating one or more functions of the application;
displaying at the user device a search result object for each search result;
displaying at the user device a category or a tag for each category or tag represented in the search results;
receiving an input from a user interface indicating one of the categories or tags of the search results, which has been selected; and
based on the one of the categories or tags, displaying a subset of the search results corresponding to the one of the categories or tags.

2. The method of claim 1, further comprising:
generating a search wrapper comprising the search query and other data;
transmitting the search wrapper to a search server;
receiving the search results from the search server, wherein the search results comprise access information, display component data, a result score, and a filter link;
generating a first filter signal based on the one of the categories or tags and transmitting the first filter signal to the search server; and
receiving from the search server the subset of the search results or an indication as to which of the search results not to display.

3. The method of claim 2, further comprising:
receiving a user input based on the subset of the search results;
generating a second filter signal based on the user input and transmitting the second filter signal to the search server; and
receiving from the search server a portion of the subset or an indication as to which of the search results in the subset not to display.

4. The method of claim 1, further comprising sorting or grouping via the processor the search result objects based on categories of the search results.

5. The method of claim 1, further comprising filtering, sorting or grouping via the processor the search result objects based on the one of the categories or tags.

6. The method of claim 1, further comprising displaying:
the search result objects corresponding to the one of the categories or tags; and
the categories or tags represented in the search results corresponding to the one of the categories or tags.

7. The method of claim 1, further comprising:
displaying a user-selectable function for each application function represented in a category subset of the search results;
receiving a user input indicating a selected application function; and
based on the selected application function, displaying search result objects having tags corresponding to the selected application function.

8. The method of claim 1, further comprising:
displaying a menu including the categories or the tags;
receiving a user input indicating a menu selection; and
filtering the search results based on the menu selection.

9. A system for search results, the system comprising:
a processor;
a memory; and
a first application stored in the memory and including instructions, which are executable by the processor and that are configured to
receive as a user input a search query at a user device,
obtain search results based on the search query, wherein each of the search results comprises
access information including a reference to a second application executable on the processor and indicating an operation for the second application to enter an operating state, wherein the second application provides content related to the search query while in the operating state,
a category, and
a tag indicating one or more functions of the application,
displaying at the user device a search result object for each search result,
displaying at the user device a category or a tag for each category or tag represented in the search results,
receiving an input from a user interface indicating one of the categories or tags of the search results, and
based on the one of the categories or tags, displaying at the user device a subset of the search results corresponding to the one of the categories or tags.

10. The system of claim 9, wherein the operations further comprise:
generating a search wrapper comprising the search query and other data;
transmitting the search wrapper to a search server;
receiving the search results from the search server, wherein the search results comprise access information, display component data, a result score, and a filter link;
generating a first filter signal based on the one of the categories or tags and transmitting the first filter signal to the search server; and
receiving from the search server the subset of the search results or an indication as to which of the search results not to display.

11. The system of claim 10, wherein the operations further comprise:
receiving a user input based on the subset of the search results;
generating a second filter signal based on the user input and transmitting the second filter signal to the search server; and
receiving from the search server a portion of the subset or an indication as to which of the search results in the subset not to display.

12. The system of claim 9, wherein the operations further comprise sorting or grouping the search result objects based on categories of the search results.

13. The system of claim 9, wherein the operations further comprise filtering, sorting or grouping the search result objects based on the one of the categories or tags.

14. The system of claim 9, wherein the operations further comprise displaying:
the search result objects corresponding to the one of the categories or tags; and
the categories or tags represented in the search results corresponding to the one of the categories or tags.

15. The system of claim 9, further comprising:
displaying a user-selectable function for each application function represented in a category subset of the search results;
receiving a user input indicating a selected application function; and
based on the selected application function, displaying search result objects having tags corresponding to the selected application function.

16. The system of claim 9, wherein the operations further comprise:
displaying a menu including the categories or the tags;
receiving a user input indicating a menu selection; and
filtering the search results based on the menu selection.

17. A user device comprising:
the system of claim 9;
the user interface; and
a display configured to display the search results, the categories and the tags.

18. A search server comprising a processor;
a memory; and
a first application stored in the memory and including instructions, which are executable by the processor and that are configured to
receive a search query from a user device at the search server, and
conduct a search based on the search query to obtain search results, wherein each of the search results comprises
access information including a reference to a second application executable on the processor and indicating an operation for the second application to enter an operating state, wherein the second application provides content related to the search query while in the operating state,
a category, and
a tag indicating one or more functions of the application,
transmitting the search results to the user device,
receiving from the user device a first filter signal indicating one of the categories or tags,
based on the first filter signal, filtering the search results to a subset of the search results corresponding to the category or the tag, and
transmitting the subset or an indication as to which of the search result not to display to the user device.

19. The search server of claim 18, wherein the operations further comprise:
receiving a search wrapper comprising the search query and other data; and
transmitting from the search server the subset of the search results or an indication as to which of the search results not to display, wherein the search results comprise access information, display component data, a result score, and a filter link.

20. The search server of claim 19, wherein the operations further comprise:
receiving a user input based on the subset of the search results;
receiving a second filter signal from the user device for a category or tag corresponding to only a selected portion of the search results in the subset; and
transmitting from the search server at least one of (i) the selected portion of the subset and (ii) an indication as to which of the search results in the subset not to display.

21. The search server of claim 19, wherein the operations further comprise filtering, sorting, and grouping the search results based on the one of the categories or tags.
